(19) United States
(12) Patent Application Publication
(10) Pub. No.: US 2025/0212951 A1
(43) Pub. Date: Jul. 3, 2025

(54) AEROSOL GENERATING DEVICE

(71) Applicant: KT&G CORPORATION, Daejeon (KR)

(72) Inventor: Hwikyeong AN, Seoul (KR)

(73) Assignee: KT&G CORPORATION, Daejeon (KR)

(21) Appl. No.: 18/851,403

(22) PCT Filed: Apr. 5, 2023
(86) PCT No.: PCT/KR2023/004581

§ 371 Date: Sep. 26, 2024

(30) Foreign Application Priority Data
Apr. 6, 2022 (KR) 10-2022-0042847
Aug. 17, 2022 (KR) 10-2022-0102595

(51) Int. Cl. A24F 40/40; A24F 40/20; H01F 7/02

(52) U.S. Cl. CPC A24F 40/40; H01F 7/0263; A24F 40/20

(57) ABSTRACT

An aerosol generating device is provided. The aerosol generating device includes: a body providing an insertion space defining an opening; a heater; a battery configured to supply power to the heater; a controller configured to control the power supplied to the heater; a cap provided with a first magnet and configured to slide between a first position at which the opening of the insertion space is opened and a second position at which the opening is closed by the cap; and a second magnet fixed to the body to correspond to the first position.

### TECHNICAL FIELD

The present disclosure relates to an aerosol generating device.

### BACKGROUND ART

An aerosol generating device is a device that extracts certain components from a medium or a substance by producing an aerosol. The medium may contain a multicomponent substance. The substance contained in the medium may be a multicomponent flavoring substance. For example, the substance contained in the medium may include a nicotine component, an herbal component, and/or a coffee component. Recently, various research on aerosol generating devices has been conducted.

### DISCLOSURE OF INVENTION

### Technical Problem

It is an objective of the present disclosure to provide an aerosol generating device with improved smell-proof performance.

It is another objective of the present disclosure to provide an aerosol generating device with improved user convenience.

The objectives of the present disclosure are not limited to the objectives described above, and other objectives not stated herein will be clearly understood by those skilled in the art from the following description.

### Solution to Problem

According to one aspect of the subject matter described in this application, an aerosol generating device includes: a body providing an insertion space defining an opening; a heater for heating the insertion space; a battery configured to supply power to the heater; a controller configured to control the power supplied to the heater; a cap provided with a first magnet and configured to slide between a first position at which the opening of the insertion space is opened and a second position at which the opening is closed by the cap; and a second magnet fixed to the body to correspond to the first position.

### Advantageous Effects of Invention

According to at least one of the embodiments of the present disclosure, a smell inside an aerosol generating device may be blocked from spreading to the outside.

According to at least one of the embodiments of the present disclosure, the convenience of use of an aerosol generating device may be improved.

Further scope of applicability of the present disclosure will become apparent from the following detailed description. However, it should be understood that the detailed description and specific embodiments such as preferred embodiments of the present disclosure are given by way of example only, since various changes and modifications within the idea and scope of the present disclosure may be clearly understood by those skilled in the art.

### BRIEF DESCRIPTION OF DRAWINGS

FIGS. 1 to 21 illustrate examples of an aerosol generating device according to embodiments of the present disclosure.

### MODE FOR THE INVENTION

Description will now be given in detail according to exemplary embodiments disclosed herein, with reference to the accompanying drawings. For the sake of brief description with reference to the drawings, the same or equivalent components are provided with the same or similar reference numerals, and description thereof will not be repeated.

In the following description, a suffix such as “module” and “unit” may be used to refer to elements or components. Use of such a suffix herein is merely intended to facilitate description of the specification, and the suffix itself is not intended to give any special meaning or function.

In the present disclosure, that which is well known to one of ordinary skill in the relevant art has generally been omitted for the sake of brevity. The accompanying drawings are used to help easily understand the technical idea of the present disclosure and it should be understood that the idea of the present disclosure is not limited by the accompanying drawings. The idea of the present disclosure should be construed to extend to any alterations, equivalents, and substitutes besides the accompanying drawings.

It will be understood that although the terms “first”, “second”, etc. may be used herein to describe various elements, these elements should not be limited by these terms. These terms are only used to distinguish one element from another.

It will be understood that when a component is referred to as being “connected to” or “coupled to” another component, it may be directly connected to or coupled to another component, or intervening components may be present. On the other hand, when a component is referred to as being “directly connected to” or “directly coupled to” another component, there are no intervening components present.

As used herein, a singular representation is intended to include a plural representation unless the context clearly indicates otherwise.

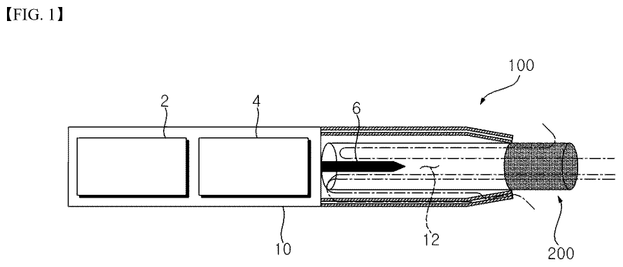

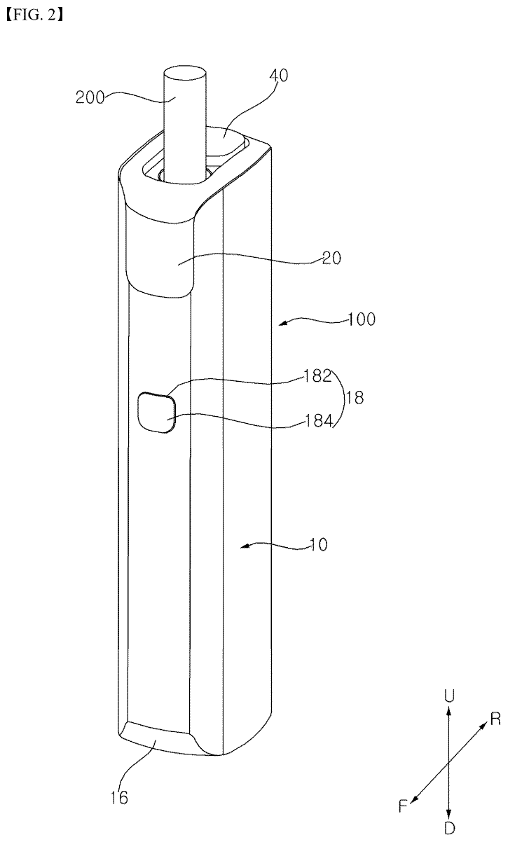

Referring to FIGS. 1 and 2, an aerosol generating device 100 may include a body 10. The body 10 may be elongated. For example, the body 10 may be elongated in an up-and-down direction.

The body 10 may include a cavity. The body 10 may be formed in the shape of a pipe having a cavity therein. For example, the body 10 may have the shape of an elongated cuboid with rounded corners.

The body 10 may be open to at least one side in a longitudinal direction of the body 10 from the cavity therein. The longitudinal direction of the body 10 may be the up-and-down direction. For example, the body 10 may be open to both sides in the up-and-down direction from the cavity therein.

The aerosol generating device 100 may include an upper case 20 defining one surface or side of the body 10. The upper case 20 may cover one open side of the body 10. For example, the upper case 20 may define an upper surface of the body 10.

A side end of the upper case 20 may extend in the longitudinal direction of the body 10. The body 10 may be cut to correspond to a shape of the upper case 20. For example, opposite side ends of an edge of the upper case 20 may extend in the longitudinal direction of the body 10.

The upper case 20 may include a cap 40. The cap 40 may cover an insertion space 12. The cap 40 may reciprocate along a predetermined route to open and close the insertion space 12. For example, the cap 40 may open and close the insertion space 12 in a sliding manner.

The aerosol generating device 100 may include a lower cover 16 defining another side of the body 10. The another side may be opposite to the one side where the upper case 20 is disposed. The another side may be an end in the longitudinal direction of the body 10. For example, the upper case 20 may be disposed at an upper end in the longitudinal direction of the body 10, and the lower cover 16 may be disposed at a lower end in the longitudinal direction of the body 10.

The lower cover 16 may cover another open side of the body 10. The another side may be opposite to the one side. The lower cover 16 may have the shape of a cross section of the body 10. A portion of the lower cover 16 may extend in the longitudinal direction of the body 10. For example, the lower cover 16 may cover an open bottom of the body 10, and opposite side ends of an edge of the lower cover 16 may be bent to extend upward in the longitudinal direction of the body 10.

The edge of the lower cover 16 may face an edge of the body 10. The body 10 may be cut into a shape corresponding to a shape of the lower cover 16. The lower cover 16 may prevent an inside of the body 10 from being exposed to the outside. For example, opposite side ends of the edge of the lower cover 16 may be bent and extend to define the another side of the body 10, and a portion of a lateral surface of the body 10 may be cut to correspond to the shape of the lower cover 16.

The aerosol generating device 100 may provide the insertion space 12. The insertion space 12 may be open at one side of the aerosol generating device 100. For example, the insertion space 12 may be open at a top of the aerosol generating device 100.

The insertion space 12 may be elongated. A longitudinal direction of the insertion space 12 may correspond to the longitudinal direction of the body 10. For example, the insertion space 12 and the body 10 may be elongated in the up-and-down direction.

A stick 200 may be inserted into the insertion space 12. The insertion space 12 may have a shape corresponding to a shape of the stick 200. For example, the stick 200 may have a cylindrical shape elongated in the up-and-down direction, and the insertion space 12 may have a hollow cylindrical shape elongated in the up-and-down direction.

The aerosol generating device 100 may include a heater 6 coupled to the body 10. The heater 6 may heat the insertion space 12. The heater 6 may heat the stick 200 that is inserted into the insertion space 12. The heater 6 may heat the stick 200 to generate an aerosol. The heater 6 may be an electro-resistive heater. The heater 6 may be made of a conductive metal.

The heater 6 may protrude from a bottom of the insertion space 12 toward the open side of the insertion space 12. The heater 6 may have an elongated rod shape. The heater 6 may have a pointed top end (or tip). The stick 200 may be inserted into the insertion space 12, and the heater 6 may be inserted into the stick 200.

The aerosol generating device 100 may include a battery 2. The battery 2 may be disposed in the body 10. The battery 2 may supply power to the heater 6. The heater 6 may generate heat directly using a current supplied from the battery 2. The battery 2 may supply power to a controller 4.

The aerosol generating device 100 may include the controller 4. The controller 4 may be disposed in the body 10. The battery 2, the controller 4, and the heater 6 may be arranged in a line. For example, the controller 4 may be disposed between the battery 2 and the heater 6.

The controller 4 may control the overall operation of the aerosol generating device 100. The controller 4 may control the operation of at least one of the battery 2 and the heater 6. The controller 4 may check the state of each of the components of the aerosol generating device 100 to determine whether the aerosol generating device 100 is in an operable state.

A lower end of the stick 200 may be inserted into the insertion space 12, and an upper end of the stick 200 may be exposed to the outside from the insertion space 12. A user may inhale air while holding the exposed upper end of the stick 200 in his or her mouth. Air may be introduced into the aerosol generating device 100, so as to flow together with an aerosol to the airway of the user.

The aerosol generating device 100 may include a key assembly 18. The key assembly 18 may include a button key 184. The key assembly 18 may include a button hole 182 into which the button key 184 is inserted so as to allow the button key 184 to perform a reciprocating motion.

The button key 184 may be disposed on one surface of the body 10. The button hole 182 may be formed on one surface of the body 10. The button key 184 may be inserted into the button hole 182 to perform a reciprocating motion. For example, when the button key 184 is pressed, the button key 184 may move toward the inside of the body 10, and may move to return to its original state.

The button key 184 and the button hole 182 may have shapes corresponding to each other. For example, the button key 184 and the button hole 182 may have rectangular shapes corresponding to each other. The button hole 182 and the button key 184 may be elongated to one side to thereby have a long axis and a short axis. The button hole 182 and the button key 184 may be configured to have the same horizontal length and vertical length. For example, the button hole 182 and the button key 184 may be a square with the same horizontal length and vertical length.

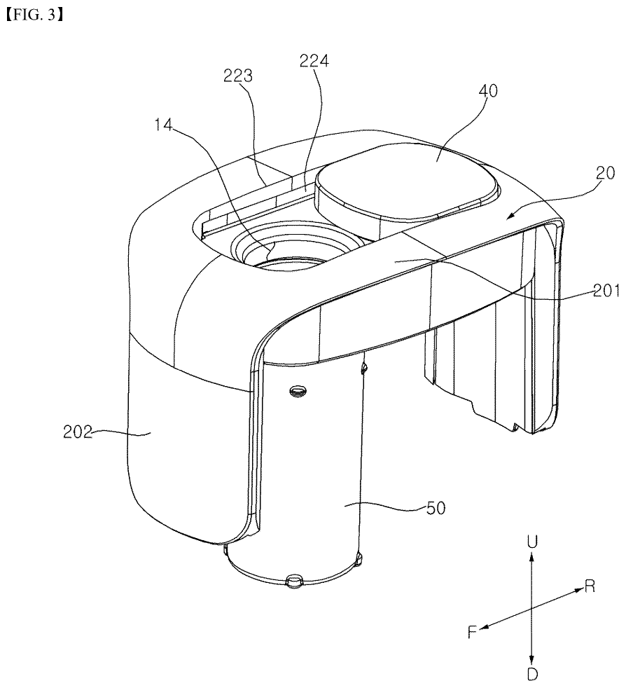

Referring to FIG. 3, the upper case 20 may include an upper cover 201. The upper cover 201 may define one surface of the body 10. The upper cover 201 may cover the one open side of the body 10. The upper cover 201 may extend in a direction intersecting the longitudinal direction of the body 10. For example, the upper cover 201 may be elongated in a front-and-rear direction.

The upper case 20 may include a side cover 202 bent at an edge of the upper cover 201 to extend in the longitudinal direction of the body 10. The side cover 202 may extend from each of opposite ends of the upper cover 201 in the longitudinal direction of the body 10. The side cover 202 may define a lateral surface of the body 10. For example, the side cover 202 may extend downward in the longitudinal direction of the body 10 from each of front and rear ends of the upper cover 201 to thereby define lateral surfaces of the body 10.

The upper case 20 may include the cap 40. The cap 40 may be disposed on an upper side of the insertion space 12 in the up-and-down direction. The cap 40 may cover an opening 14 of the insertion space 12. The cap 40 may perform a reciprocating motion along a predetermined route. The predetermined route may be located outside the insertion space 12. The cap 40 may be configured to open or close the opening 14 of the insertion space 12. The cap 40 may be slidingly coupled to the body 10. For example, the cap 40 may slidingly reciprocate on the predetermined route to open and close the opening 14.

The cap 40 may open the opening 14 at a first position. The cap 40 may close the opening 14 at a second position. The cap 40 may slide to move between the first position and the second position. For example, the cap 40 may slide to perform a linear reciprocating motion between the first position and the second position. Hereinafter, a direction that connects the first position and the second position will be referred to as a movement direction of the cap 40. For example, the movement direction of the cap 40 may be the front-and-rear direction.

The upper case 20 may be provided with a cap slot 223 into which the cap 40 is inserted. The cap 40 may be inserted into the cap slot 223 to move. A first end of the cap slot 223 may be the first position, and a second end of the cap slot 223 may be the second position. The upper case 20 may be recessed to define the cap slot 223. The upper case 20 may be recessed into the body 10 to form the cap slot 223. For example, the cap slot 223 may be recessed downward from the upper case 20.

The cap slot 223 may be elongated in the movement direction of the cap 40. The cap slot 223 may be formed linearly. The cap slot 223 may define a linear movement route or path. For example, the cap slot 223 may be elongated in the front-and-rear direction, namely, the movement direction of the cap 40.

A cross-sectional area of the cap slot 223 may be greater than a cross-sectional area of the insertion space 12. For example, the cap slot 223 may have a rectangular shape with a greater cross-sectional area than the cylindrical insertion space 12.

The insertion space 12 may communicate with the outside through the cap slot 223 of the upper case 20. The insertion space 12 may be opened and closed by the cap 40 of the upper case 20. For example, the insertion space 12 may be open when in use and covered by the cap 40 when not in use. The stick 200 may pass through the cap slot 223 to be inserted into the insertion space 12.

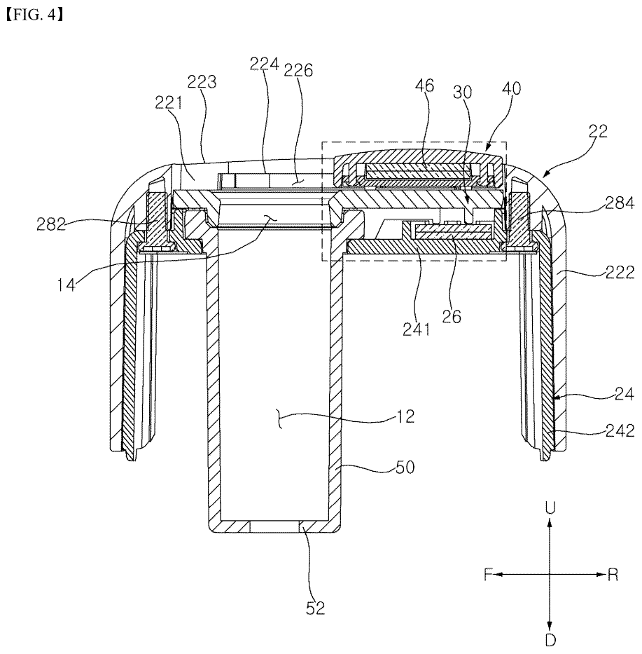

Referring to FIG. 4, the upper case 20 may include a second upper case 24 that defines one side of the body 10 and a first upper case 22 that covers the second upper case 22.

The second upper case 24 may include a second upper cover 241. The second upper cover 241 may define one surface of the body 10. An extractor 50 may be coupled to the second upper cover 241. The second upper cover 241 may extend in a direction perpendicular to the longitudinal direction of the body 10. For example, the body 10 may be elongated in the up-and-down direction, and the second upper cover 241 may be elongated in the front-and-rear direction.

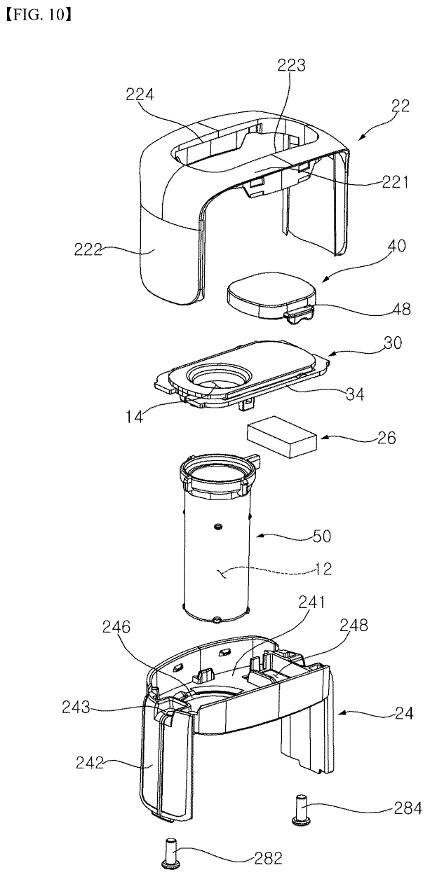

A second magnet 26 may be disposed on the second upper cover 241. The second upper cover 241 may include a magnet room 248 (see FIG. 10) in which the second magnet 26 is disposed.

The second upper case 24 may include a second side cover 242. The second side cover 242 may extend in the longitudinal direction of the body 10. For example, the second side cover 242 may extend in the up-and-down direction.

The second side cover 242 may be connected to the second upper cover 241. The second side cover 242 may be bent and extend from the second upper cover 241. The second side cover 242 may define a lateral surface of the body 10. For example, the second side cover 242 may be bent vertically at each of front and rear ends of the second upper cover 241 to extend downward, so as to define front and rear surfaces of the body 10.

The first upper case 22 may include a first upper cover 221. The first upper cover 221 may be fixed to the second upper cover 241. The first upper cover 221 may cover the second upper cover 241. For example, the first upper cover 221 may be disposed on top of the second upper cover 241, so as to be fixed through first and second screws 282 and 284.

The first upper cover 221 may define one surface of the body 10. For example, the first upper cover 221 may define the upper surface of the body 10.

The first upper cover 221 may be elongated in the movement direction of the cap 40. For example, the first upper cover 221 may be elongated in the front-and-rear direction, which is the movement direction of the cap 40.

The first upper cover 221 may have the cap slot 223. The cap 40 may be inserted into the cap slot 223 of the first upper cover 221. The cap 40 may move along the cap slot 223 formed in the first upper cover 221. The cap slot 223 may be elongated in the movement direction of the cap 40. The cap slot 223 may be elongated between the first position and the second position. For example, the first upper cover 221 may be elongated in the front-and-rear direction and have the cap slot 223 extending in the front-and-rear direction, and the cap 40 may be inserted into the cap slot 223 to slide in the front-and-rear direction.

The first upper case 22 may include a first side cover 222. The first side cover 222 may extend in the longitudinal direction of the body 10. For example, the first side cover 222 may extend in the up-and-down direction, which is the longitudinal direction of the body 10.

The first side cover 222 may be connected to the first upper cover 221. The first side cover 222 may be bent and extend from the first upper cover 221. The first side cover 222 may define a lateral surface of the body 10. For example, the first side cover 222 may be bent vertically at each of front and rear ends of the first upper cover 221 to extend downward, so as to define front and rear surfaces of the body 10.

The first upper case 22 may include a case rail 224. The case rail 224 may be elongated along the movement direction of the cap 40. The case rail 224 may be elongated along a longitudinal direction of the cap slot 223. For example, the case rail 224 may be elongated in the front-and-rear direction.

The case rail 224 may correspond to a rail 34 of a plate 30. For example, the case rail 224 and the rail 34 of the plate 30 may be elongated in the front-and-rear direction, and may be arranged side by side in the up-and-down direction.

The case rail 224 may be adjacent to the cap slot 223. The case rail 224 may be formed on an inner surface of the cap slot 223. The inner surface of the cap slot 223 may be depressed outward to form the case rail 224. The inner surface of the cap slot 223 may be recessed outward to define the case rail 224. A height of the case rail 224 may be less than a height of the inner surface of the cap slot 223. The height refers to a length in the up-and-down direction (or a vertical length). For example, the case rail 224 may be formed such that a lower portion of the inner surface of the cap slot 223 is recessed outward from a center of the cap slot 223. For example, the case rail 224 may be formed such that a lower portion of the inner surface of the cap slot 223 in a left-and-right direction is recessed. For example, the inner surface of the cap slot 223 in the left-and-right direction may define the case rail 224 on the bottom.

The case rail 224 may cover a slider 48 of the cap 40. The case rail 224 may have a movement space 226 to allow the slider 48 of the cap 40 to move. The movement space 226 may be partitioned by the case rail 224. The movement space 226 may be elongated along the movement direction of the cap 40. The movement direction of the cap 40 may be the longitudinal direction of the cap slot 223. For example, the movement space 226 may be elongated along the front-and-rear direction, which is the movement direction of the cap 40.

The case rail 224 may prevent the cap 40 from being separated from the body 10. For example, the cap 40 provided with a first magnet 46 may receive an upward repulsive force from the second magnet 26, but upward separation of the cap 40 from the body 10 may be prevented as the case rail 224 covers the slider 48.

The aerosol generating device 100 may include the first magnet 46 disposed in the cap 40. The first magnet 46 may be fixed inside the cap 40. The first magnet 46 may extend in a direction perpendicular to the longitudinal direction of the body 10. For example, the first magnet 46 may have a thin thickness to extend perpendicular to the up-and-down direction, and may be fixed inside the cap 40.

The aerosol generating device 100 may include the second magnet 26 that interacts with the first magnet 46. The second magnet 26 may correspond to the first position. The second magnet 26 may be fixed to the first position. For example, the first position may be a rear end of the cap slot 223, and the second magnet 26 may be disposed on a lower side of the rear end of the cap slot 223.

The second magnet 26 may be fixed to the body 10. The second magnet 26 may be fixed to the second upper case 24. For example, the second magnet 26 may be fixed to the magnet room 248 of the second upper cover 241 at a lower side of the first position.

The second magnet 26 may be disposed between the second upper cover 241 and the plate 30.

The first magnet 46 and the second magnet 26 may interact with each other. The second magnet 26 and the first magnet 46 may repel each other. For example, the second magnet 26 and the first magnet 46 may exert a repulsive force on each other. The second magnet 26 may push the cap 40 provided with the first magnet 46 away.

The aerosol generating device 100 may include the first screw 282 to allow the first upper case 22 and the second upper case 24 to be coupled to each other. The second upper case 24 and the first upper case 22 may be coupled by the first screw 282 in a direction from the inside of the body 10 to the outside. The first screw 282 may extend in the longitudinal direction of the body 10. The second upper case 24 and the first upper case 22 may be coupled by the first screw 282 in the longitudinal direction of the body 10. For example, the first screw 282 may be fastened upward to allow the second upper case 24 and the first upper case 22 to be coupled to each other.

The first screw 282 may correspond to the second position. The first screw 282 may be adjacent to the second position. For example, the second position may be a front of the body 10, and the first screw 282 may be fixed to the front of the body 10 to correspond to the second position.

The first screw 282 may be a magnetic material. The first screw 282 may be made of a metal material. For example, the first screw 282 may be a ferromagnetic material made of stainless steel.

The first screw 282 may interact with the first magnet 46. For example, an attractive force acting between the first magnet 46 and the first screw 282 may increase as the cap 40 provided with the first magnet 46 is closer to the second position, causing the first magnet 46 and the first screw 282 to pull towards each other.

The aerosol generating device 100 may include the second screw 284 that allows the first upper case 22 and the second upper case 24 to be coupled to each other. The second upper case 24 and the first upper case 22 may be coupled by the second screw 284 from the inside of the body 10 toward the outside. The second screw 284 may extend in the longitudinal direction of the body 10. The second upper case 24 and the first upper case 22 may be coupled by the second screw 284 in the longitudinal direction of the body 10. For example, the second screw 284 may be fastened upward to allow the second upper case 24 and the first upper case 22 to be coupled to each other.

The second screw 284 may be a magnetic material. The second screw 284 may be made of a metal material. For example, the second screw 284 may be a ferromagnetic material made of stainless steel.

The second screw 284 may interact with the first magnet 46. For example, an attractive force acting between the first magnet 46 and the second screw 284 may increase as the cap 40 provided with the first magnet 46 is closer to the first position, causing the first magnet 46 and the second screw 284 to pull towards each other.

The magnitude of a magnetic force acting between the first magnet 46 and the second screw 284 may be less than the magnitude of a magnetic force acting between the first magnet 46 and the second magnet 26. For example, the magnitude of an attractive force acting between the first magnet 46 and the second screw 284 may be less than the magnitude of a repulsive force acting between the first magnet 46 and the second magnet 26. Accordingly, the cap 40 may be moved to the second position by receiving a repulsive force from the first position.

The aerosol generating device 100 may include the plate 30 elongated along the movement direction of the cap 40. The cap 40 may be slidingly coupled to the plate 30. The plate 30 may be disposed between the second upper case 24 and the first upper case 22. For example, the cap 40 may move in the front-and-rear direction, and the plate 30 may be elongated in the front-and-rear direction.

The cap 40 may be in contact with the plate 30. The cap 40 may move along the plate 30.

The plate 30 may be exposed to the outside through the cap slot 223.

The plate 30 may be provided with the opening 14 in communication with the insertion space 12. The plate 30 may be coupled to the extractor 50 defining the insertion space 12. The insertion space 12, the opening 14, and the cap slot 223 may communicate with each other. For example, the insertion space 12, the opening 14, and the cap slot 223 may be arranged in a line in the up-and-down direction so as to communicate with each other. The insertion space 12 may communicate with the outside through the opening 14 and the cap slot 223.

The aerosol generating device 100 may include the extractor 50 defining the insertion space 12. The insertion space 12 may be elongated. The extractor 50 may be elongated in the longitudinal direction of the insertion space 12. The extractor 50 may include a bottom 54 with which the stick 200 inserted into the insertion space 12 comes into contact. The opening 14 may be disposed on one side in a longitudinal direction of the extractor 50, and the bottom 54 may be formed on another side in the longitudinal direction of the extractor 50. The bottom 54 and the opening 14 may be opposite with respect to the longitudinal direction of the extractor 50. A through-hole 52 may be formed at the bottom 54 of the extractor 50. The heater 6 may be inserted into the through-hole 52 formed at the bottom 54 of the extractor 5.

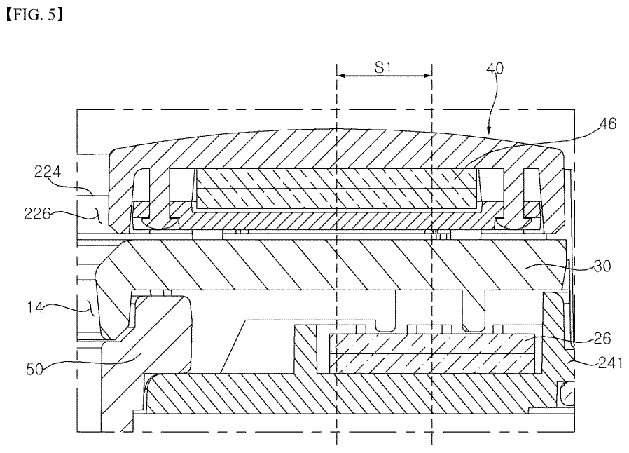

Referring to FIG. 5, the first magnet 46 may be disposed in the cap 40. The cap 40 may open the opening 14 at the first position. The second magnet 26 may be disposed to correspond to the first position. The second magnet 26 may be disposed at a lower side of the first position. The second magnet 26 may be spaced apart from the lower side of the first position in a direction from the second position to the first position. For example, the second magnet 26 may be spaced rearward from the lower side of the first position.

When the cap 40 is at the first position, a center of the first magnet 46 and a center of the second magnet 26 may be spaced apart from each other in the movement direction of the cap 40 by a predetermined distance s1. The second magnet 26 may be spaced apart from the first magnet 46 positioned at the first position in a direction from the second position to the first position by the predetermined distance s1. The predetermined distance s1 may be greater than zero. For example, the second magnet 26 may be spaced rearward relative to the first magnet 46 of the cap 40 positioned at the first position by the predetermined distance s1. As the first magnet 46 and the second magnet 26 are staggered with each other at the first position, the cap 40 may receive a repulsive force acting in a horizontal direction near the first position.

When the cap 40 moves, a minimum value of a horizontal separation distance s2 between the second magnet 26 and the first magnet 46 may be the predetermined distance s1. As the cap 40 approaches the second position, the horizontal separation distance s2 between the second magnet 26 and the first magnet 46 may increase from the predetermined distance s1.

A repulsive force may act between the first magnet 46 and the second magnet 26. The first magnet 46 and the second magnet 26 may face each other. The first magnet 46 and the second magnet 26 may be arranged such that the same poles face each other. For example, the first magnet 46 may be placed with its S-pole facing down, and the second magnet 26 may be placed with its S-pole facing up. For example, the first magnet 46 may be placed with its N-pole facing down, and the second magnet 26 may be placed with its N-pole facing up.

The first magnet 46 and the second magnet 26 may exert a repulsive force on each other. The second magnet 26 may receive a repulsive force from the first magnet 46. The second magnet 26 may be fixed to the body 10 so as not to move. For example, the second magnet 26 may be fixed to the magnet room 248 of the second upper case 24, so as to prevent the second magnet 26 from moving even when receiving the repulsive force from the first magnet 46.

The first magnet 46 may receive a repulsive force from the second magnet 26. The repulsive force that the first magnet 46 receives from the second magnet 26 may include force in the longitudinal direction of the body 10. For example, the first magnet 46 may receive an upward repulsive force from the second magnet 26. Due to the case rail 224, the first magnet 46 may not be separated upward when receiving an upward repulsive force.

The repulsive force that the first magnet 46 receives from the second magnet 26 may include force in the movement direction of the cap 40. For example, when the cap 40 is at the first position, the first magnet 46 may receive a forward repulsive force from the second magnet 26.

When the first magnet 46 receives the force in the movement direction of the cap 40 from the second magnet 26, the cap 40 may move along the cap slot 223. For example, the first magnet 46 of the cap 40 at the first position may receive a forward repulsive force from the second magnet 26, and the cap 40 may move forward due to the forward repulsive force.

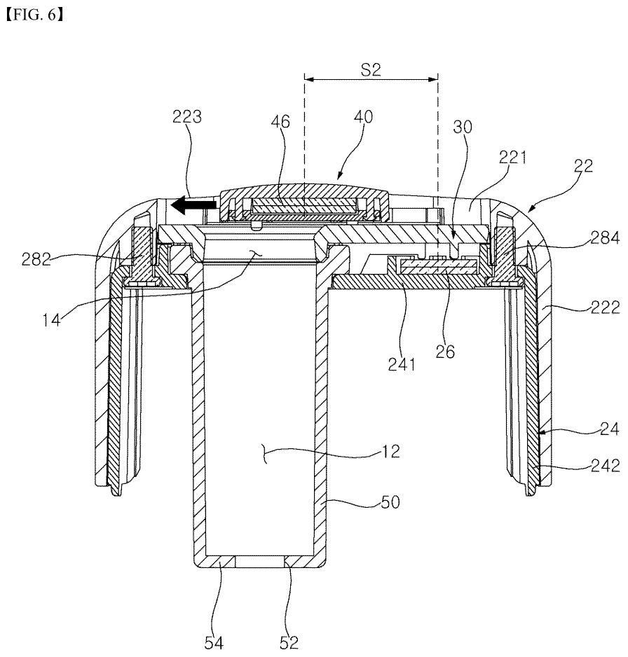

Referring to FIG. 6, the first magnet 46 and the second magnet 26 may exert a repulsive force on each other. A repulsive force acting on the cap 40 provided with the first magnet 46 acts in a direction from the second magnet 26 to the first magnet 46. The repulsive force includes a repulsive force in a direction from the plate 30 to the cap 40. For example, the first magnet 46 may receive an upward repulsive force from the second magnet 26, but upward separation of the cap 40 may be prevented by the case rail 224.

The repulsive force acting in a direction from the second magnet 26 to the first magnet 46 includes a repulsive force in a direction from the first position to the second position. The repulsive force acting from the first position to the second position causes the cap 40 to move from the first position to the second position. The cap 40 may move to the first position along the cap slot 223 due to a repulsive force acting in the horizontal direction. For example, the cap 40 may receive a forward repulsive force in a direction from the first position to the second position, and the forward repulsive force may allow the cap 40 to move forward from the first position to thereby reach the second position.

The cap 40 may be moved from the first position to the second position by the repulsive force acting between the first magnet 46 and the second magnet 26, thereby closing the opening 14.

Accordingly, when the aerosol generating device is not in use, the opening of the insertion space may be closed by the magnetic force.

The repulsive force acting between the first magnet 46 and the second magnet 26 may decrease as the cap 40 is away from the first position. As the cap 40 is away from the first position, power for moving the cap 40 to the first position may also decrease.

The aerosol generating device 100 may include the first screw 282 fixed to the body 10 to correspond to the second position. As the cap 40 approaches the second position while moving along the cap slot 223, an attractive force acting between the first screw 282 and the first magnet 46 may increase. The attractive force acting between the first screw 282 and the first magnet 46 may supplement a decreasing repulsive force between the first magnet 46 and the second magnet 26. The attractive force acting between the first screw 282 and the first magnet 46 may cause the cap 40, which is away from the first position, to move to the second position.

The attractive force acting between the first screw 282 and the first magnet 46 may be directed in a direction from the first magnet 46 to the first screw 282. The attractive force acting between the first screw 282 and the first magnet 46 may include an attractive force directed from the cap 40 to the inside of the body 10. For example, the attractive force acting between the first screw 282 and the first magnet 46 may include a downward attractive force. The cap 40 may come into contact with the plate 30 to move only between the first position and the second position, without moving in the longitudinal direction of the body 10.

The attractive force acting between the first screw 282 and the first magnet 46 may include force acting in a direction from the first position to the second position. For example, the attractive force acting between the first screw 282 and the first magnet 46 may include a forward attractive force. The cap 40 may be moved from the first position to the second position by an attractive force acting in a direction from the first position to the second position.

The repulsive force acting between the second magnet 26 and the first magnet 46 may decrease with an increasing distance from the first position, and the attractive force acting between the first screw 282 and the first magnet 46 may cause the cap 40 to reach the second position.

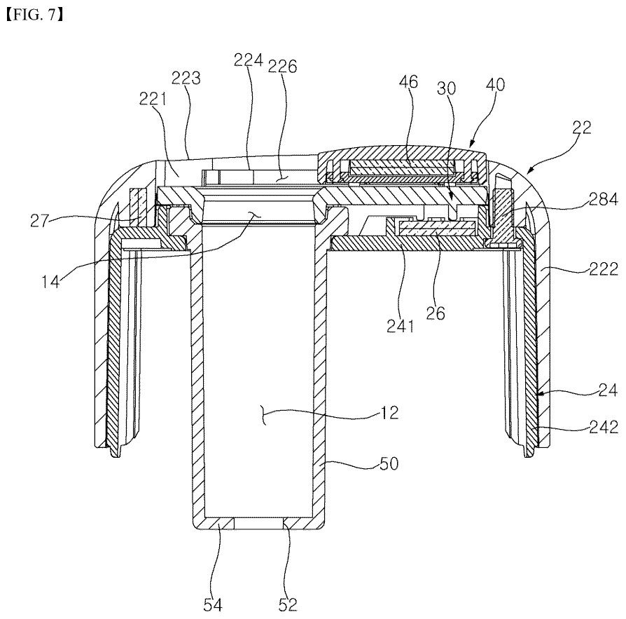

Referring to FIG. 7, the aerosol generating device 100 may include a third magnet 27 fixed to the body 10 to correspond to the second position. The third magnet 27 and the first magnet 46 may exert an attractive force on each other. The third magnet 27 may cause the cap 40 to move to the second position.

The third magnet 27 may extend in the longitudinal direction of the body 10. A longitudinal direction of the third magnet 27 may be parallel to the longitudinal direction of the body 10. The third magnet 27 may be disposed to face the cap slot 223. For example, the third magnet 27 may extend in the up-and-down direction, and may be disposed to face the front-and-rear direction.

The third magnet 27 may be fixed to the first upper case 22. The third magnet 27 may be disposed between the first upper case 22 and the second upper case 24. The third magnet 27 may be adjacent to a first end of the plate 30. The second screw 284 may be adjacent to a second end in a longitudinal direction of the plate 30, and the third magnet 27 may be adjacent to a first end in the longitudinal direction of the plate 30 opposite to the second end. For example, the second screw 284 may be adjacent to a rear end of the plate 30, and the third magnet 27 may be adjacent to a front end of the plate 30.

The third magnet 27 may be placed with a pole opposite to a pole of the first magnet 46 that faces the plate 30 facing the plate 30. The third magnet 27 may be placed with a pole corresponding to a pole of the second magnet 26 that faces the plate 30 facing the plate 30.

The aerosol generating device 100 may include the third magnet 27 and the first screw 282 to correspond to the second position. The third magnet 27 and the first screw 282 may be spaced apart from each other in a direction perpendicular to the longitudinal direction of the body 10. For example, the aerosol generating device 100 may include both the third magnet 27 and the first screw 282, and the third magnet 27 and the first screw 282 may be spaced apart from each other in the left-and-right direction so as to be fixed to the body 10 to correspond to the second position.

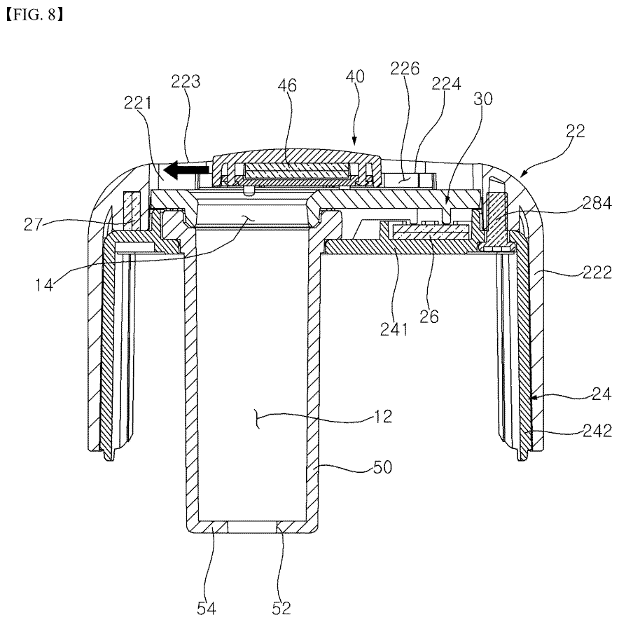

Referring to FIG. 8, a repulsive force acting between the first magnet 46 and the second magnet 26 may cause the cap 40 to move from the first position to the second position. An attractive force acting between the first magnet 46 and the third magnet 27 may increase as the cap 40 is closer to the second position. For example, as the cap 40 moves from the first position to the second position, the repulsive force acting between the first magnet 46 and the second magnet 26 may decrease, whereas the attractive force acting between the first magnet 46 and the third magnet 27 may increase. Accordingly, the attractive force acting between the first magnet 46 and the third magnet 27 may supplement moving power of the cap 40, which decreases as the repulsive force between the first magnet 46 and the second magnet 26 decreases.

Thus, the cap 40 may move from the first position to the second position.

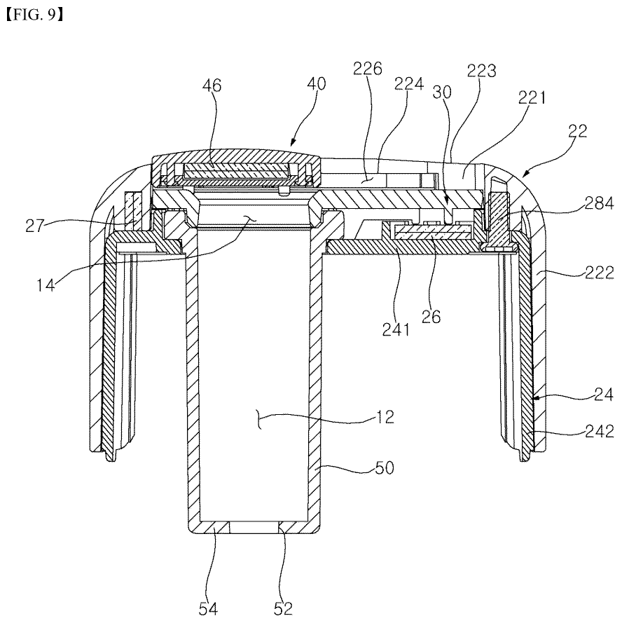

Referring to FIG. 9, the cap 40 may be stopped when the cap 40 reaches the second position. The cap 40 may be stopped near a first end in the longitudinal direction of the cap slot 223, which is adjacent to the second position. The cap 40 may be stopped when coming into contact with a second stopper 38 formed on the rail 34 adjacent to the second position.

The cap 40 stopped at the second position may remain stationary by a repulsive force acting between the first magnet 46 and the second magnet 26 and an attractive force acting between the third magnet 27 and the first magnet 46.

The cap 40 that has reached the second position may be released from the second position when an external force is applied. For example, the cap 40 that has reached the second position may remain stationary at the second position due to the magnetic force, and the cap 40 may be released from the second position when an external force is applied by a user, allowing the cap 40 to move along the cap slot 223.

Referring to FIG. 10, the extractor 50 may be coupled between the first upper case 22 and the second upper case 24. The extractor 50 may be inserted into an extractor coupling portion 246 formed at the second upper case 24. For example, the extractor 50 may be inserted into the extractor coupling portion 246 from a top of the second upper case 24.

The second magnet 26 may be disposed between the first upper case 22 and the second upper case 24. The second magnet 26 may be disposed in the magnet room 248 formed in the second upper case 24. The plate 30 may be disposed on top of the second magnet 26.

The plate 30 may be disposed between the second upper case 24 and the first upper case 22. The plate 30 may be in contact with the first upper case 22 and the second upper case 24.

The opening 14 of the insertion space 12 may be formed in the plate 30. The opening 14 may be formed through the plate 30. The opening 14 may correspond to the insertion space 12.

The plate 30 may be elongated in the movement direction of the cap 40. For example, the plate 30 may be elongated in the front-and-rear direction, which is the movement direction of the cap 40.

The rail 34 may be formed on the plate 30 to allow the cap 40 to move. The rail 34 may be elongated in the movement direction of the cap 40. The rail 34 may be formed at an edge of the plate 30. The edge of the plate 30 may be recessed to define the rail 34. The edge of the plate 30 may be depressed to form the rail 34. For example, the rail 34 may be formed such that an edge in the longitudinal direction of the plate 30 is depressed to extend in an elongated manner.

The cap 40 may be disposed between the plate 30 and the first upper case 22. The cap 40 may come into contact with the plate 30. The cap 40 may be inserted into the cap slot 223 of the first upper case 22. The cap 40 may move along the cap slot 223 of the first upper case 22. The cap 40 may move along the rail 34 of the plate 30.

The cap 40 may include the slider 48 that corresponds to the rail 34 of the plate 30. The slider 48 may be formed on a lateral surface of the cap 40. The slider 48 may be formed on one side of the lateral surface of the cap 40 and another side of the lateral surface of the cap 40 opposite to the one side of the lateral surface. The slider 48 may extend in a direction perpendicular to the same imaginary plane as the movement direction of the cap 40. For example, the slider 48 may be formed on each of left and right sides of the cap 40.

The first upper case 22 and the second upper case 24 may be coupled by the first and second screws 282 and 284. The first and second screws 282 and 284 may be inserted into the second upper case 24 to be fixed to the first upper case 22. For example, the first and second screws 282 and 284 may be inserted from a bottom of the second upper case 24 to be fixed to the first upper case 22.

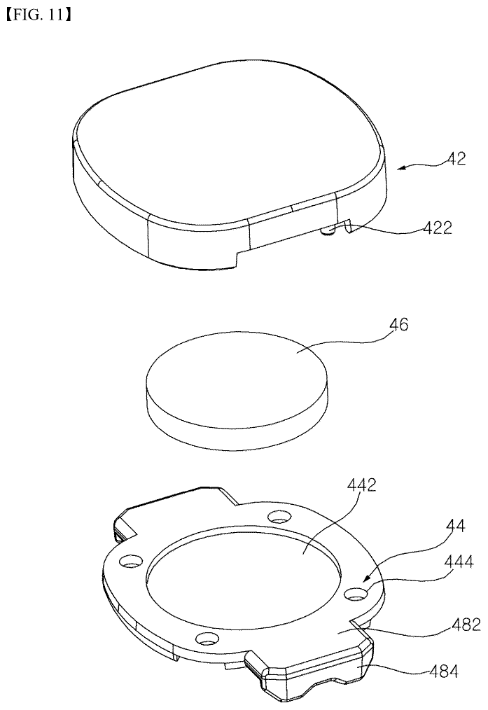

Referring to FIG. 11, the cap 40 may include the first magnet 46. The first magnet 46 may be disposed in the cap 40. Opposite poles of the first magnet 46 may face a lower cap 44 and an upper cap 42. The first magnet 46 may be fixed to the cap 40. For example, the first magnet 46 may be fixed to the cap 40 in a manner that the opposite poles of the first magnet 46 face the lower cap 44 and the upper cap 42.

The first magnet 46 may correspond to a shape of the cap 40. The first magnet 46 may correspond to a size of the cap 40. For example, the first magnet 46 may have a disk shape with a thin thickness, so as to be disposed in the cap 40.

The cap 40 may include the upper cap 42. The upper cap 42 may cover the first magnet 46.

The upper cap 42 may define an upper surface of the cap 40. The upper cap 42 may define a lateral surface of the cap 40. For example, the upper cap 42 may define the upper surface of the cap 40, and may be bent from the upper surface to form the lateral surface of the cap 40.

The cap 40 may include the lower cap 44. The lower cap 44 may define a lower surface of the cap 40. The first magnet 46 may be disposed at the lower cap 44. The first magnet 46 may be disposed between the lower cap 44 and the upper cap 42. The lower cap 44 may include a magnet recess 442 in which the first magnet 46 is disposed. The magnet recess 442 may correspond to the first magnet 46. For example, the first magnet 46 may have a circular shape, and the magnet recess 442 of the lower cap 44 may have a circular shape corresponding to the first magnet 46.

The cap 40 may include the slider 48. The slider 48 may correspond to the rail 34 of the plate 30. The slider 48 may move along the rail 34 of the plate 30. The cap 40 may move along the rail 34 of the plate 30 through the slider 48. For example, the rail 34 of the plate 30 may extend along the movement direction of the cap 40, and the slider 48 may extend from the cap 40 in a direction perpendicular to the same plane as the movement direction of the cap 40, so as to correspond to the rail 34.

The slider 48 may be inserted into the case rail 224. The slider 48 may move along the case rail 224. For example, the case rail 224 may be configured such that an inner surface of the cap slot 223 is depressed perpendicular to the movement direction of the cap 40 so as to extend in the movement direction of the cap 40, and the slider 48 may be inserted into the case rail 224 so as to move along the movement direction of the cap 40.

The slider 48 may be connected to the lower cap 44. The slider 48 may extend from the lower cap 44. The slider 48 may be formed on a side corresponding to the rail 34. For example, the slider 48 may extend from the lower cap 44 in the left-and-right direction, and the slider 48 may move in the front-and-rear direction while being engaged with the rail 34 formed in the front-and-rear direction.

The slider 48 may include a flange 482. The flange 482 may extend from lower cap 44. The flange 482 may connect a slide rib 484 and the lower cap 44. The flange 482 may support weight or load of the lower cap 44. The flange 482 may extend from the cap 40 in a direction from the cap 40 to the rail 34. The flange 482 may be elongated in the movement direction of the cap 40. For example, the flange 482 may extend toward the rail 34 disposed at each of the left and right of the cap 40.

The slider 48 may include the slide rib 484. The slide rib 484 may move in the movement direction of the cap 40 while being engaged with the rail 34. The slide rib 484 may support weight or load of the cap 40.

The slide rib 484 may be bent by extending from the lower cap 44. The slide rib 484 may be bent at the flange 482. The slide rib 484 may be elongated in the movement direction of the cap 40. For example, the flange 482 may extend from the lower cap 44 toward the rail 34, and the slide rib 484 may be bent at the flange 482.

The upper cap 42 may be coupled to the lower cap 44. The first magnet 46 may be disposed between the upper cap 42 and the lower cap 44, and the upper cap 42 and the lower cap 44 may be coupled to each other. The upper cap 42 and the lower cap 44 may be coupled by a screw. The upper cap 42 and the lower cap 44 may be coupled by fastening a screw. The upper cap 42 and the lower cap 44 may be coupled by welding a screw. The upper cap 42 and the lower cap 44 may be coupled by an adhesive member. The upper cap 42 and the lower cap 44 may be coupled by an adhesive. The upper cap 42 and the lower cap 44 may be coupled by being engaged with each other. The upper cap 42 and the lower cap 44 may be coupled by brazing. The upper cap 42 and the lower cap 44 may be injection molded products.

The upper cap 42 may include a cap screw 422. The lower cap 44 may have a through-hole 444 into which the cap screw 422 is inserted. The through-hole 444 may correspond to the cap screw 422.

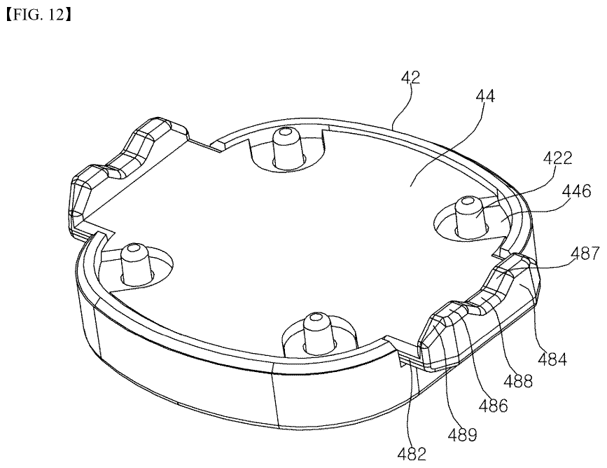

Referring to FIG. 12, the slider 48 may include the flange 482 and the slide rib 484. The slide rib 484 may include a slide base 486 in contact with the rail 34. The slide base 486 may move in contact with the rail 34. The slide base 486 may define one surface of the slide rib 484. The one surface may be a surface facing the rail 34. For example, the slide base 486 may define a lower surface of the slide rib 484, and the slide rib 484 may move in contact with the rail 34 of the plate 30.

The slide rib 484 may include a slide groove 488. The slide groove 488 may be a groove carved into the slide rib 484. The slide groove 488 may be formed by cutting the slide rib 484. The slide groove 488 may be formed in a direction opposite to a direction from the slide rib 484 to the rail 34. The slide groove 488 may be formed in a middle portion of the slide base 486. For example, the slide groove 488 may be formed in the middle portion of the slide base 486 extending in the movement direction of the cap 40.

The slide groove 488 may be cut from the slide base 486. The slide groove 488 may be in the form of being carved out from the slide base 486. For example, the slide groove 488 may be a groove carved upward from the slide base 486.

The slide groove 488 and the slide base 486 may be connected to each other. The slide rib 484 may include a groove slope 487 that is an inclined surface connecting the slide groove 488 and the slide base 486. For example, the slide rib 484 may include a groove slope 487 that obliquely connects the slide base 486 on a lower side thereof and the slide groove 488 on an upper side thereof.

The slide rib 484 may have an end portion cut in the movement direction of the cap 40. The slide rib 484 may have an end portion inclined in the movement direction of the cap 40. The slider 48 may include a guide slope 489 formed by cutting an end portion of the slide rib 484 in an inclined manner. The guide slope 489 may be formed such an end portion in a longitudinal direction of the slide base 486 is inclined upward.

The guide slope 489 may be disposed at an end in a longitudinal direction of the slide rib 484. The guide slope 489 may be disposed at an end in the longitudinal direction of the slide base 486. For example, the guide slope 489 may be disposed at each of front and rear ends of the slide rib 484.

The slide base 486 may be disposed between the guide slope 489 and the slide groove 488. The slide groove 488 may be formed between slide bases 486 spaced apart from each other in the movement direction of the cap 40.

The cap screw 422 may be inserted into the through-hole 444 of the lower cap 44. The cap screw 422 may protrude when inserted into the through-hole 444 of the lower cap 44. For example, the cap screw 422 may be inserted into the through-hole 444 of the lower cap 44 so as to protrude downward from the lower cap 44.

The lower cap 44 may have a screw recess 446 on a surface facing the plate 30. The lower cap 44 may have the screw recess 446 on a side where the cap screw 422 protrudes. The screw recess 446 may be provided adjacent to the through-hole 444. The screw recess 446 may be formed at a periphery portion of the through-hole 444. For example, the screw recess 446 may be formed on a lower surface of the lower cap 44 in a manner of being recessed upward at the periphery portion of the through-hole 444.

The cap screw 422 may be welded such that the lower cap 44 and the upper cap 42 are coupled to each other. A screw welded material 424 of the cap screw 422 may be formed on the screw recess 446. The screw welded material 424 of the cap screw 422 may define one surface of the lower cap 44. For example, the cap screw 422 protruding downward may be welded to form a lower surface of the lower cap 44.

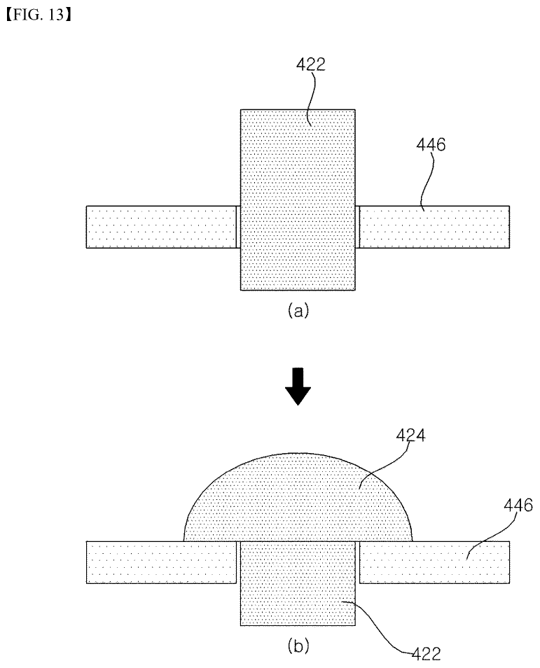

Referring to FIG. 13, the cap screw 422 may be welded. The cap screw 422 may be melted such that the upper cap 42 and the lower cap 44 are coupled to each other. The cap screw 422 may be welded to form the screw welded material 424. The cap screw 422 protruding to the lower cap 44 may be welded, and an end portion of the protruding cap screw 422 may be welded to be formed bluntly.

The screw welded material 424 may be in contact with the screw recess 446. The screw welded material 424 may be fixed to the screw recess 446. The screw welded material 424 may be disposed on the screw recess 446, and may define one surface of the lower cap 44 on which the screw recess 446 is formed.

The screw welded material 424 may be formed in various shapes. The screw welded material 424 may have a flat surface to define one surface of the lower cap 44. The screw welded material 424 may have a shape corresponding to the screw recess 446. An exposed surface of the screw welded material 424 may be a curved surface.

The cap screw 422 may be melted to spread on the screw recess 446, and the screw welded material 424 hardened as the temperature drops may be fixed to the screw recess 446.

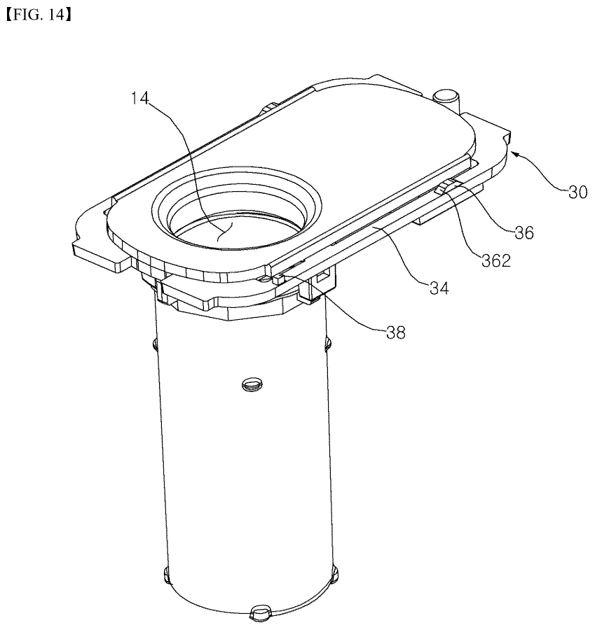

Referring to FIG. 14, the plate 30 may include a first stopper 36 formed on the rail 34. The first stopper 36 may be formed at an end of the rail 34. The first stopper 36 may correspond to the first position. The first stopper 36 may be disposed at a second end of the plate 30 opposite to a first end of the plate 30 where the opening 14 is formed. For example, the rail 34 may be elongated in the movement direction of the cap 40, and the first stopper 36 may be disposed adjacent to an end of the rail 34 that corresponds to the first position.

The first stopper 36 may be adjacent to the second screw 284. For example, the second screw 284 may be adjacent to a rear end of the plate 30 and the first stopper 36 may be disposed at a rear end of the rail 34 to be adjacent to the second screw 284.

The first stopper 36 may protrude from the rail 34. The first stopper 36 may be a projection protruding from the rail 34.

The first stopper 36 may have an end portion inclined in the movement direction of the cap 40, namely, in a longitudinal direction of the rail 34. The first stopper 36 may include a stopper slope 362 that is an inclined surface connected to the rail 34. For example, the first stopper 36 may include the stopper slope 362 that is an inclined surface connected to an upper surface of the rail 34.

The stopper slope 362 may be formed at each of both ends of the first stopper 36. Here, the ends may be ends in the longitudinal direction of the rail 34.

The plate 30 may include the second stopper 38 formed on the rail 34. The second stopper 38 may be formed at an end in the longitudinal direction of the rail 34. The second stopper 38 may be adjacent to the opening 14. For example, the opening 14 may be adjacent to a front end of the plate 30, and the second stopper 38 may be disposed at a front end of the rail 34 to be adjacent to the opening 14.

The second stopper 38 may be adjacent to the first screw 282. For example, the first screw 282 may be disposed on a front side of the plate 30, and the second stopper 38 may be disposed at the front end of the rail 34 so as to be adjacent to the first screw 282.

The second stopper 38 may protrude from the rail 34.

The first stopper 36 may be disposed at a first end in the longitudinal direction of the rail 34, and the second stopper 38 may be disposed at a second end in the longitudinal direction of the rail 34. The first end and the second end may be opposite to each other.

The first stopper 36 and the second stopper 38 may have different shapes. The second stopper 38 may protrude further than the first stopper 36. For example, a vertical height of the second stopper 38 may be greater than a vertical height of the first stopper 36.

Accordingly, the slider 48 may be prevented from being moved upward of the second stopper 38.

The plate 30 may include a plate rib 35 extending in an elongated manner. The plate rib 35 may extend in the longitudinal direction of the plate 30. The plate rib 35 may be disposed adjacent to the rail 34.

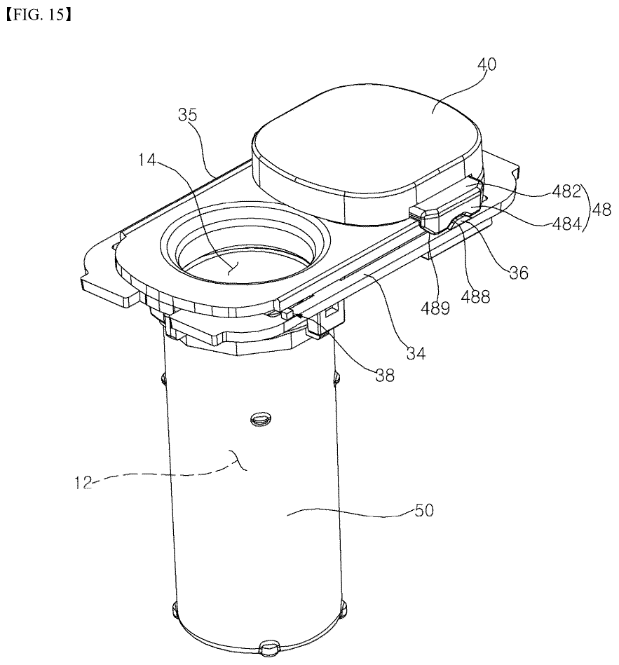

Referring to FIG. 15, the first stopper 36 may correspond to the slide groove 488 of the slider 48. The first stopper 36 may be fitted into the slide groove 488 of the slider 48. The slide groove 488 may be engaged with the first stopper 36 to thereby fix the cap 40. This may allow the cap 40 to be fixed to the first position despite the repulsive force of the first magnet 46 and the second magnet 26.

Accordingly, a user may insert the stick into the insertion space while fixing the cap to the first position.

Thus, the convenience of use of the aerosol generating device may be improved.

The guide slope 489 of the slider 48 may correspond to the stopper slope 362 of the first stopper 36. The groove slope 487 of the slider 48 may correspond to the stopper slope 362 of the first stopper 36. The cap 40 may move toward the first position from the second position, and the guide slope 489 may approach the stopper slope 362. For example, the guide slope 489 may be formed at each of front and rear ends of the slide rib 484, and the guide slope 489 at the rear end of the slide rib 484 may approach the guide slope 489 at a front end of the first stopper 36 as the cap 40 approaches the first position.

The guide slope 489 may guide the stopper slope 362 to the slide groove 488. The guide slope 489 may mitigate impact between the slider 48 and the first stopper 36. For example, the cap 40 may approach the first position, and the guide slope 489 of the slider 48 may slide up along the stopper slope 362 of the first stopper 36.

Accordingly, the cap 40 may be raised along the first stopper 36 while moving backward.

The first stopper 36 may be engaged with the slide groove 488 after passing the slide base 486. When the slide groove 488 is engaged with the first stopper 36, the cap 40 may be fixed to the first position.

The cap 40 may be released from the first position. As the cap 40 is released from the first position, the groove slope 487 may slide on the first stopper 36. For example, the groove slope 487 may slide up along the stopper slope 362 formed at a rear end of the first stopper 36.

The slide base 486 may be positioned on top of the first stopper 36. As the cap 40 is released from the first position, the slide base 486 may slide down along the stopper slope 362 of the first stopper 36.

Accordingly, the cap 40 may be easily separated from the first stopper 36.

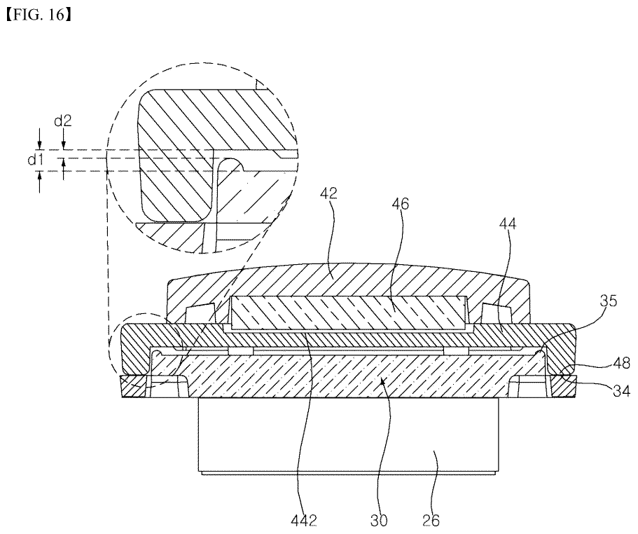

Referring to FIG. 16, the cap 40 may be spaced apart from the plate 30. The cap 40 may face the plate 30. One surface of the cap 40 that faces the plate 30 may be spaced apart from the plate 30 in the longitudinal direction of the body 10 by a predetermined distance d1. For example, a lower surface of the cap 40 that faces the plate 30 may be spaced upward from the plate 30 by the predetermined distance d1.

Accordingly, friction between the plate 30 and the cap 40 may be reduced.

One surface of the cap 40 that faces the plate 30 may be spaced apart from the plate rib 35 in the longitudinal direction of the body 10 by a predetermined distance d2. For example, a lower surface of the cap 40 that faces the plate 30 may be spaced upward from the plate rib 35 by the predetermined distance d2.

Accordingly, friction between the plate rib 35 and the cap 40 may be suppressed.

The slide base 486 of the slider 48 may be in contact with the rail 34. The slider 48 of the cap 40 may move in contact with the rail 34 of the plate 30.

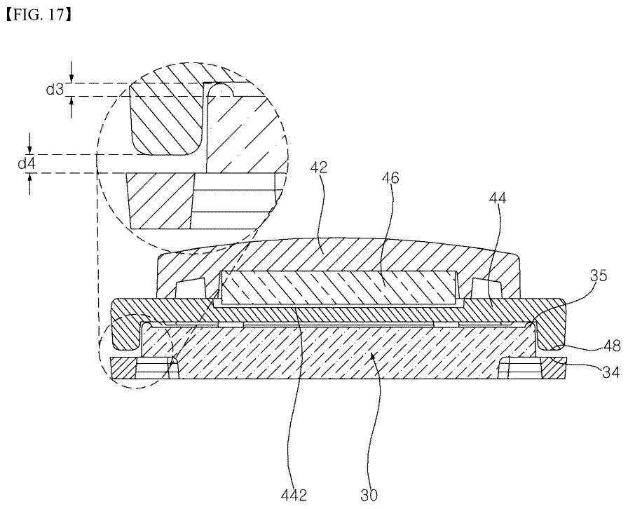

Referring to FIG. 17, the cap 40 may be spaced apart from the plate 30. One surface of the cap 40 that faces the plate 30 may be spaced apart from the plate 30 in the longitudinal direction of the body 10 by a predetermined distance d3. For example, a lower surface of the cap 40 that faces the plate 30 may be spaced upward from the plate 30 by the predetermined distance d3.

Accordingly, friction between the plate 30 and the cap 40 may be reduced.

The cap 40 may be in contact with the plate rib 35. One surface of the cap 40 that faces the plate 30 may be in contact with the plate rib 35. The cap 40 may be in contact with the plate rib 35 so as to move in the longitudinal direction of the plate rib 35. The slider 48 of the cap 40 may be spaced apart from the rail 34 of the plate 30 by a predetermined distance d4. For example, the slider 48 of the cap 40 may be spaced upward from the plate rail 34 by the predetermined distance d4.

Accordingly, friction between the slider 48 of the cap 40 and the rail 34 may be suppressed.

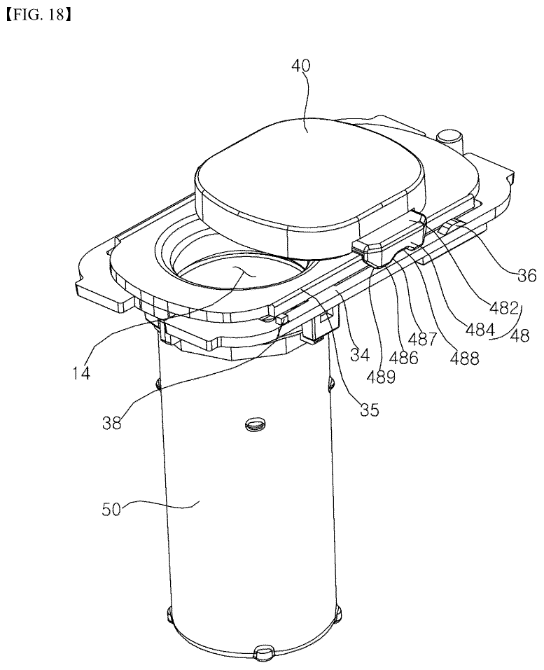

Referring to FIG. 18, as the slide groove 488 is separated from the first stopper 36, the cap 40 may be released from the first position. The cap 40 may move from the first position to the second position. The slider 48 may move along the rail 34. For example, the cap 40 may be released from the first position at the rear to thereby move forward along the rail 34.

As the cap 40 moves from the first position to the second position, the opening 14 may be closed. The opening 14 may be covered by the cap 40. For example, as the cap 40 is released from the first position and approaches the second position, the opening 14 at the front may be covered by the cap 40.

As the opening 14 is covered by the cap 40, an area of the insertion space 12 exposed to the outside may be reduced accordingly.

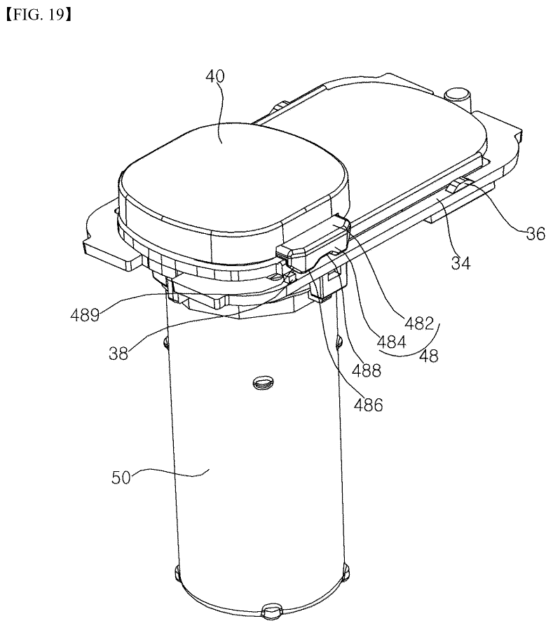

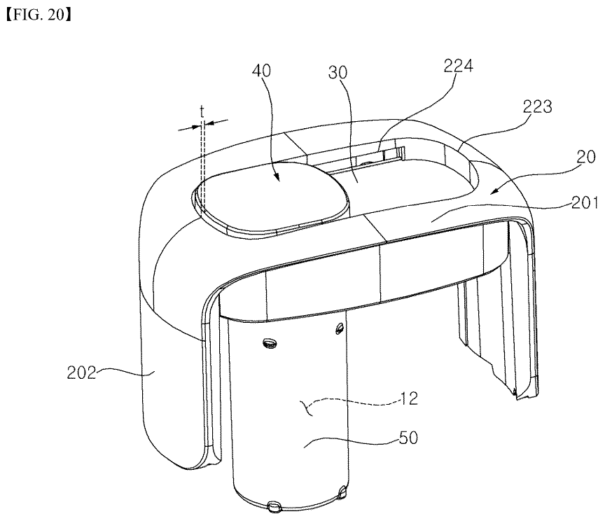

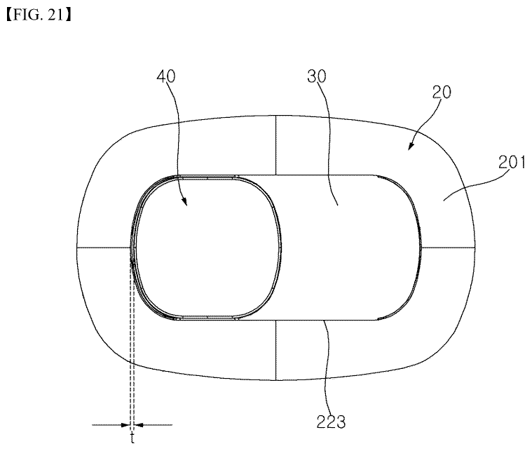

Referring to FIGS. 19 to 21, the cap 40 may move to the second position. The cap 40 may stop at the second position. The cap 40 may stop when the slider 48 collides with the second stopper 38. The second stopper 38 may prevent the cap 40 from moving. The cap 40 may be stopped when the guide slope 489 comes into contact with the second stopper 38.

The second stopper 38 may be disposed on the rail 34, so as to prevent the cap 40 from colliding with an end in the longitudinal direction of the cap slot 223. When the cap 40 is at the second position, the cap 40 and an end of the cap slot 223 adjacent to the cap 40 may be spaced apart from each other by a predetermined distance t. For example, the cap 40 may stop at the second position, and a lateral surface of the cap 40 and a front end of the cap slot 223 may be spaced apart from each other by the predetermined distance t.

Accordingly, damage to the cap 40 may be reduced.

As a result, durability of the aerosol generating device may be improved.

Referring to FIGS. 1 to 21, an aerosol generating device according to one aspect of the present disclosure may include: a body providing an insertion space open at one side; a heater adjacent to the insertion space to be coupled to the body; a battery configured to supply power to the heater; a controller configured to control the power supplied to the heater; a cap configured to open or close the opening of the insertion space, slidingly coupled to the body to move between a first position at which the opening is opened and a second position at which the opening is closed, and provided with a first magnet; and a second magnet fixed to the body to correspond to the first position.

According to another aspect of the present disclosure, the first magnet and the second magnet may exert a repulsive force on each other.

According to another aspect of the present disclosure, the second magnet may be spaced apart from the first magnet at the first position in a direction from the second position to the first position.

According to another aspect of the present disclosure, the aerosol generating device may further include a first screw fixed to the body to correspond to the second position. The first screw and the first magnet may exert an attractive force on each other.

According to another aspect of the present disclosure, the body may include a rail elongated between the first position and the second position. The cap may include a slider configured to move on the rail.

According to another aspect of the present disclosure, the body may include a first stopper protruding from the rail corresponding to the first position, so as to allow the cap to be fixed to the first position. The cap may include a slide groove formed by cutting one surface of the slider that faces the rail, so as to be engaged with the first stopper.

According to another aspect of the present disclosure, the first stopper may have a stopper slope at an end portion thereof in an inclined manner in a longitudinal direction of the rail. The slider may have a guide slope at an end portion thereof in an inclined manner in the longitudinal direction of the rail, so as to correspond to the stopper slope.

According to another aspect of the present disclosure, the slider may include a groove slope inclined from the slide groove in the longitudinal direction of the rail, so as to correspond to the stopper slope.

According to another aspect of the present disclosure, the aerosol generating device may further include an upper case defining one side of the body. The upper case may have a cap slot elongated between the first position and the second position, and into which the cap is inserted.

According to another aspect of the present disclosure, the body may include a second stopper in contact with the slider at the second position. The second stopper may be configured such that the cap in contact with the second stopper and an end in a longitudinal direction of the cap slot adjacent to the second position are spaced apart from each other by a predetermined distance.

According to another aspect of the present disclosure, the upper case may have a case rail that covers the slider and extends in a longitudinal direction of the cap slot.

According to another aspect of the present disclosure, the body may include a third magnet fixed to the body to correspond to the second position. The third magnet and the first magnet may exert an attractive force on each other.

According to another aspect of the present disclosure, the cap may include a lower cap and an upper cap that covers the lower cap and the first magnet. The upper cap may be provided with a cap screw. The lower cap may have a through-hole through which the cap screw passes, and may have a screw recess to which the cap screw is fixed by welding at a position corresponding to the through-hole.

According to another aspect of the present disclosure, the cap may be spaced apart from the body, and the slider may move in contact with the rail.

According to another aspect of the present disclosure, the aerosol generating device may further include a plate on which the rail is formed. The plate may include a plate rib elongated in a longitudinal direction of the rail. The slider may be spaced apart from the rail, and the cap may move in contact with the plate rib.

Certain embodiments or other embodiments of the disclosure described above are not mutually exclusive or distinct from each other. Any or all elements of the embodiments of the disclosure described above may be combined with another or combined with each other in configuration or function.

For example, a configuration “A” described in one embodiment of the disclosure and the drawings, and a configuration “B” described in another embodiment of the disclosure and the drawings may be combined with each other. Namely, although the combination between the configurations is not directly described, the combination is possible except in the case where it is described that the combination is impossible.

Although embodiments have been described with reference to a number of illustrative embodiments thereof, it should be understood that numerous other modifications and embodiments can be devised by those skilled in the art that will fall within the scope of the principles of this disclosure. More particularly, various variations and modifications are possible in the component parts and/or arrangements of the subject combination arrangement within the scope of the disclosure, the drawings, and the appended claims. In addition to variations and modifications in the component parts and/or arrangements, alternative uses will also be apparent to those skilled in the art.

1. An aerosol generating device comprising:
a body providing an insertion space defining an opening;
a heater for heating the insertion space;
a battery configured to supply power to the heater;
a controller configured to control the power supplied to the heater;
a cap provided with a first magnet and configured to slide between a first position at which the opening of the insertion space is opened and a second position at which the opening is closed by the cap; and
a second magnet fixed to the body to correspond to the first position.

2. The aerosol generating device of claim 1, the first magnet and the second magnet exert a repulsive force on each other.

3. The aerosol generating device of claim 2, wherein when the cap is in the first position, the second magnet is laterally offset from the first magnet.

4. The aerosol generating device of claim 1, further comprising a first screw fixed to the body adjacent to the cap when it is in the second position,
wherein the first screw and the first magnet exert an attractive force on each other.

5. The aerosol generating device of claim 1, wherein the body comprises a rail and the cap comprises a slider allowing the cap to slide along the rail between the first position and the second position.

6. The aerosol generating device of claim 5, wherein the body comprises a first stopper protruding from the rail and configured to engage with a slide groove of the slider to fix the cap at the first position.

7. The aerosol generating device of claim 6, wherein the first stopper comprises an inclined stopper slope and side of the slider toward the first position comprises a guide slope corresponding to the stopper slope.

8. The aerosol generating device of claim 7, wherein the slide groove of the slider is formed to have an inclined groove slope corresponding to the stopper slope.

9. The aerosol generating device of claim 5, further comprising an upper case defining one side of the body and comprising an elongated cap slot into which the cap is inserted to slide between the first position and the second position.

10. The aerosol generating device of claim 9, wherein the body comprises a second stopper protruding from the rail and configured to engage with the slider to fix the cap such that the cap is spaced apart from an end of the cap slot at the second position.

11. The aerosol generating device of claim 9, wherein the upper case comprises a case rail that covers the slider and extends in a longitudinal direction of the cap slot.

12. The aerosol generating device of claim 1, wherein the body comprises a third magnet adjacent to the cap when it is in the second position, and
wherein the third magnet and the first magnet exert an attractive force on each other.

13. The aerosol generating device of claim 1, wherein:
the cap comprises a lower cap and an upper cap that covers the lower cap and the first magnet,
the lower cap has a through-hole through which a cap screw passes to secure the lower cap and the upper cap, and
the lower cap comprises a screw recess to which the cap screw is fixed by welding at a position corresponding to the through-hole.

14. The aerosol generating device of claim 5, wherein the cap is spaced apart from the body, and the slider moves in contact with the rail.

15. The aerosol generating device of claim 5, further comprising a plate on which the rail is formed,
wherein the plate comprises a plate rib elongated in a longitudinal direction of the rail, and
wherein the slider is spaced apart from the rail, and the cap moves in contact with the plate rib.
